(19) United States
(12) Patent Application Publication
(10) Pub. No.: US 2017/0333270 A1
(43) Pub. Date: Nov. 23, 2017

(54) THERAPEUTIC MATTRESS WITH LOW VOLUME BLADDERS

(71) Applicant: HUNTLEIGH TECHNOLOGY LIMITED, BEDFORDSHIRE (GB)

(72) Inventors: Jui-Tsen PENG, Taoyuan County (TW); Glenn STROH, Marion, TX (US); Wen-Yen LEE, Bade City (TW); Wen-Hung FENG, Pingzhen City (TW); Randall P. KELCH, San Antonio, TX (US)

(73) Assignee: HUNTLEIGH TECHNOLOGY LIMITED, BEDFORDSHIRE (GB)

(21) Appl. No.: 15/329,241

(22) PCT Filed: Jul. 27, 2015
(86) PCT No.: PCT/US15/42179

§ 371 Date: Jan. 25, 2017

Related U.S. Application Data
(60) Provisional application No. 62/029,165, filed on Jul. 25, 2014.

(51) Int. Cl. A61G 7/00; A61G 7/10; A61G 7/057

(52) U.S. Cl. CPC A61G 7/001; A61G 7/05776; A61G 7/1021

(57) ABSTRACT

A patient support apparatus includes a mattress for supporting a patient, and low-volume turning bladders coupled to the mattress, and a low-volume, high pressure air supply for inflating the turning bladders.

### CROSS-REFERENCE TO RELATED APPLICATIONS

This application claims the benefit of priority to provisional U.S. Patent Application Ser. No. 62/029,165, filed Jul. 25, 2014 which relates generally to therapeutic mattress systems and is incorporated by reference herein.

### FIELD OF THE DISCLOSURE

This application relates generally to therapeutic mattress systems and more particularly to therapeutic mattress systems with low volume turning bladders.

### BACKGROUND OF THE DISCLOSURE

### Description of Related Art

Active therapeutic mattress systems are used for the care, support and comfort of patients. Typically, such mattresses include an air supply that selectively inflates inflatable bladders to provide various therapeutic treatments, such as turning, tilting, low air loss therapy, pulsation therapy, percussion therapy, and other dynamic therapies.

Typically, active therapeutic mattress systems with turning capabilities have used very large volume bladders and have relied on a high-volume blower to provide air to support and/or turn a patient. Such blowers are costly, noisy and inconvenient. Accordingly, there is a need for an improved therapeutic mattress system.

### SUMMARY OF THE DISCLOSURE

In an embodiment, a patient support apparatus comprises a mattress for supporting a patient, a first plurality of low-volume turning bladders disposed along a first longitudinal edge of the mattress, and a low-volume, high pressure air supply for inflating the first plurality of bladders. The air supply may supply between 0.1-100 L/min at a pressure between 1-200 mmHg.

The turning bladders may have a width between 10-25% of the width of the mattress, or between 15-20% of the width of the mattress. The turning bladders may have a length between 5-15% of the length of the mattress, or between 5-10% of the length of the mattress. The turning bladders may have a volume in an expanded condition between approximately 4-20% of a volume of the mattress, or less than approximately 10% of a volume of the mattress.

A second plurality of low-volume turning bladders may be disposed along a second longitudinal edge of the mattress. Straps may couple the mattress to a frame to prevent movement of the mattress. A manifold for fluidly coupling the plurality of bladders to the air supply may be provided. The manifold may comprise quick connection ports.

The mattress may be an inflatable mattress comprising a plurality of inflatable cushions. The mattress may comprise an upper layer of cushions coupled to a lower layer of cushions. The lower layer of cushions may be fluidly coupled to one another to form a single zone.

The upper layer of cushions may comprise multiple zones. The zones may comprise a head zone, a shoulder zone, a body zone and a foot zone. A substantially rigid platform may be disposed between the turning bladders.

The term “coupled” is defined as connected, although not necessarily directly. The terms “a” and “an” are defined as one or more unless this disclosure explicitly requires otherwise.

The terms “substantially,” “approximately,” and “about” are defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, or a component of a system, that “comprises,” “has,” “includes” or “contains” one or more elements or features possesses those one or more elements or features, but is not limited to possessing only those elements or features. Likewise, a method that “comprises,” “has,” “includes” or “contains” one or more steps possesses those one or more steps, but is not limited to possessing only those one or more steps. Additionally, terms such as “first” and “second” are used only to differentiate structures or features, and not to limit the different structures or features to a particular order.

A device, system, or component of either that is configured in a certain way is configured in at least that way, but it can also be configured in other ways than those specifically described.

Any embodiment of any of the systems and methods can consist of or consist essentially of—rather than comprise/include/contain/have—any of the described elements, features, and/or steps. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are presented below.

### BRIEF DESCRIPTION OF DRAWINGS

FIG. 1 is a top view of a therapeutic mattress system in accordance with an embodiment of the present disclosure;

FIG. 2 is a side view of the therapeutic mattress system of FIG. 1;

FIG. 3 is an isometric perspective view of the therapeutic mattress system of FIG. 1; and

FIG. 4 is an end view of a therapeutic mattress system of FIG. 1 shown in full patient turn.

### DETAILED DESCRIPTION OF THE DISCLOSURE

In the following detailed description, reference is made to the accompanying drawings, in which are shown exemplary but non-limiting and non-exhaustive embodiments of the invention. These embodiments are described in sufficient detail to enable those having skill in the art to practice the embodiments, and it is understood that other embodiments may be used, and other changes may be made, without departing from the spirit or scope of the disclosure. The following detailed description is, therefore, not to be taken in a limiting sense, and the scope of the invention is defined only by the appended claims. In the accompanying drawings, like reference numerals refer to like parts throughout the various figures unless otherwise specified.

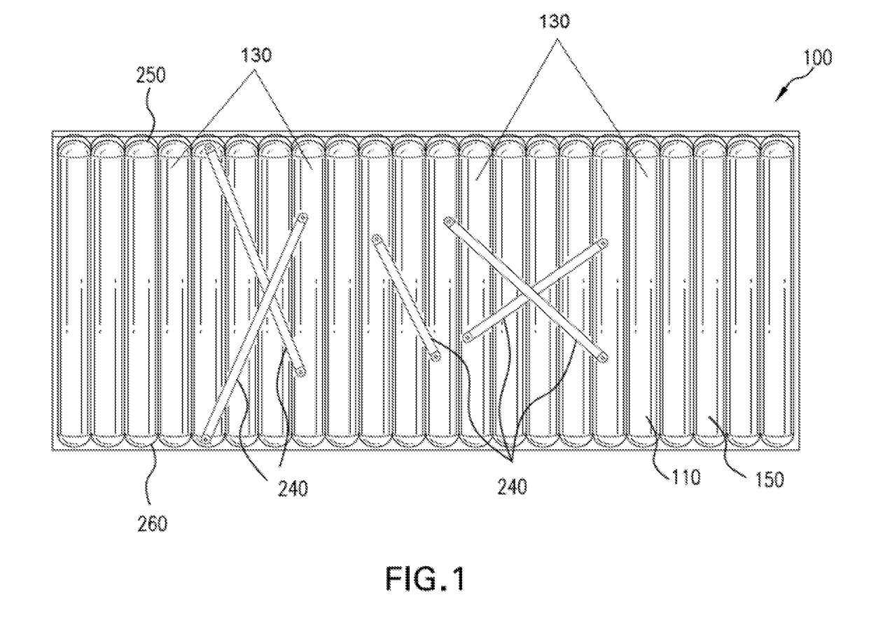

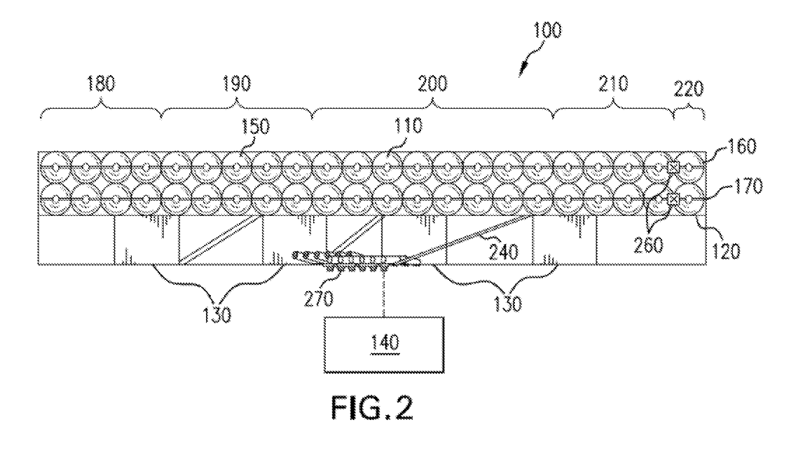

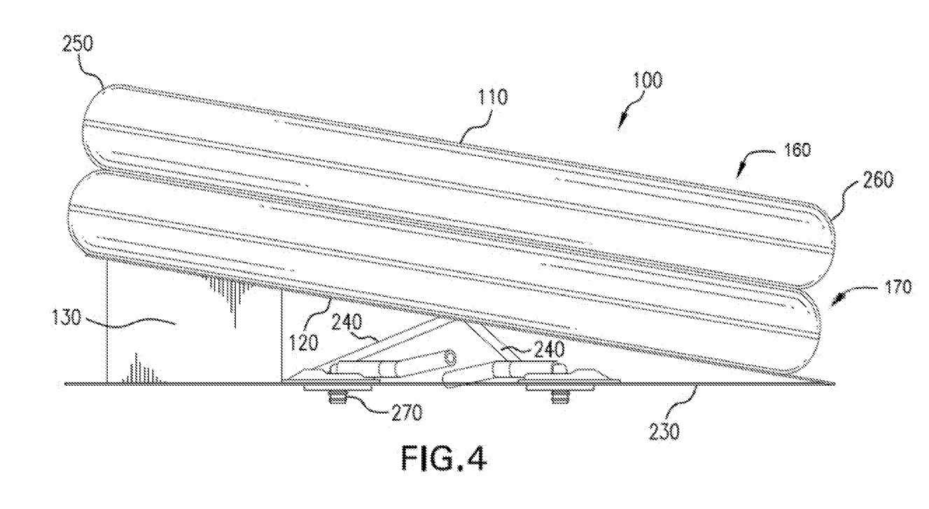

Referring to the embodiments shown in FIGS. 1-4, a patient support apparatus 100 comprises a mattress 110 located on a support platform 120, a plurality of inflatable turning bladders 130 for raising and lowering the platform, and a fluid supply 140 for inflating the turning bladders 130.

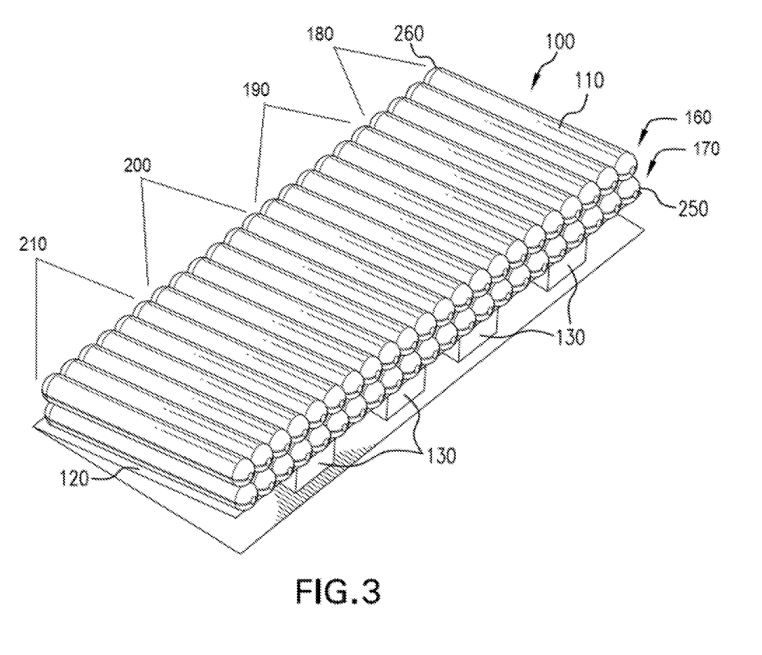

In an embodiment, the mattress 110 comprises an inflatable mattress, although non-inflatable mattresses may also be used. The inflatable mattress 110 is formed by a plurality of inflatable cushions 150. In the illustrated embodiment, the inflatable cushions 150 are arranged in two layers 160, 170. The bottom layer 170 of the inflatable cushions 150 may be fluidly coupled together to form one zone or more zones. In an embodiment, the bottom layer 170 comprises a single zone, which provides rigidity and pressure distribution across the entire zone. As shown in FIG. 3, this bottom layer 170, configured as a lower cushion, is one continuous volume. The top layer 160 of inflatable cushions may also comprise one or more zones. In an embodiment, the top layer 160 comprises four zones, a head zone 180, a shoulder zone 190, a body zone 200, and a foot zone 210. Each of the four zones may be individually controlled to provide different pressures and different amounts of support. The mattress 110 may also have an extendible length section 220 and extension valve connections 260 to accommodate adjustable length bed frames.

In an embodiment, the mattress 110 is supported by a substantially rigid support platform 120. The support platform 120 provides rigidity to allow the entire mattress 110 to be moved simultaneously. The support platform 120 may be coupled to a second support platform 230 to keep the support platform 120 and mattress 110 in a desired location while in operation. In an embodiment, straps 240 are used to couple the support platform 120 to the support platform 230. Straps 240 may prevent movement of turning bladders 130 described below.

One or more turning bladders 130 are disposed along each of the longitudinal edges 250, 260 of the mattress 110. For clarity, the turning bladders 130 are only illustrated along one side 250 of the mattress 110. In an embodiment, each turning bladder has a relatively low volume as compared to the volume of the mattress 110. For example, the volume of the turning bladders 130 in an expanded condition may be between 4-20% of the mattress volume. In one embodiment, the volume of the turning bladders 130 in an expanded condition is less than 10% of the mattress volume, and in one specific embodiment the volume is about 6.5% of the mattress volume. Any number of turning bladders 130 may be used. In the illustrated embodiment, four turning bladders 130 are provided along one side 250 of the mattress 110.

In an embodiment, the turning bladders 130 are configured as columnar bladders. FIG. 3 shows exemplary columnar turning bladders in full turn. As used herein, columnar means relatively short widths and lengths as compared to the lengths and widths of the mattress 110. In some embodiments, the widths of the bladders are between 10-25% of the width of the mattress 110. In other embodiments, the width of the bladder is less than about 20% of the width of the mattress, or is approximately 17% of the width of the mattress. In some embodiments, the lengths of the bladders are between 5-15% of the length of the mattress 110. In other embodiments, the length of the bladder is less than about 10% of the length of the mattress, or is approximately 7% of the length of the mattress. The columnar bladders may be square, circular or any other shape. The height of the turning bladders 130 determines the turning angle of the mattress 110. In one embodiment, the height of the turning bladders 130 is selected to turn the mattress 110 to a twenty (20) degree angle relative to horizontal. In another embodiment, the height of the turning bladders 130 is less than about 25% of the mattress width, or, in another specific embodiment, is 23% of the mattress width.

In one embodiment, the turning bladders 130 are removably attached to the mattress 110 to allow individual turning bladders 130 to be replaced. In one specific embodiment, the turning bladders 130 are attached by zippers.

A fluid supply 140 is coupled to the turning bladders 130 to supply fluid to, and inflate, the turning bladders 130. In an embodiment, the fluid supply 140 is an air supply that supplies between 0.1-100 L/min at a pressure between 1-200 mmHg. Compared to conventional turning mattresses, this volume is significantly lower and the pressure is significantly higher.

The fluid supply 140 may be coupled directly to the turning bladders 130 or through tubes. In an embodiment, the turning bladders 130 are coupled to a manifold 270 by tubing. The manifold 270 has quick-release fittings which allow the rapid coupling and de-coupling of the air supply to the turning bladders 130.

In operation, the low-volume, high-pressure air supply 140 selectively supplies air to the turning bladders 130 to inflate and deflate the bladders along one edge of the mattress 110. When the bladders inflate, they raise one side of the mattress 110 to turn the mattress. The bladders can then be deflated to return the mattress 110 to a horizontal position. The process can then be repeated with the turning bladders 130 on the other edge of the mattress 110.

The use of the low-volume, high pressure air supply provides several advantages over conventional systems. For example, the low-volume, high-pressure air supply is quieter and more energy efficient than a conventional high-volume, low-pressure air supply. Further, the lower volume allows quicker inflation and deflation, thereby accomplishing turning quicker.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure, and/or connections may be substituted (e.g., threads may be substituted with press-fittings or welds). Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A patient support apparatus comprising:
a mattress for supporting a patient, and
a first plurality of low-volume turning bladders disposed along a longitudinal edge of the mattress so as to turn the mattress when inflated to an expanded condition.

2. The patient support apparatus of claim 1, further comprising a low-volume, high pressure air supply disposed to inflate the first plurality of bladders.

3. The patient support apparatus of claim 2, wherein the air supply supplies air at between about 0.1-100 L/min at a pressure between 1-200 mmHg to inflate the first plurality of bladders.

4. The patient support apparatus of claim 1, wherein at least one turning bladder has a width between about 10-25% of the width of the mattress.

5. (canceled)

6. The patient support apparatus of claim 1, wherein at least one turning bladder has a length between 5-15% of the length of the mattress.

7. (canceled)

8. The patient support apparatus of claim 1, wherein at least one turning bladder has a volume in an expanded condition between approximately 4-20% of a volume of the mattress.

9. (canceled)

10. The patient support apparatus of claim 1, further comprising a second plurality of low-volume turning bladders disposed along a second longitudinal edge of the mattress, wherein the air supply inflates the second plurality of turning bladders.

11. The patient support apparatus of claim 1, further comprising straps coupled to the mattress to prevent movement of the mattress from a support platform.

12. The patient support apparatus of claim 1, further comprising a manifold that fluidly couples the plurality of bladders to the air supply.

13. The patient support apparatus of claim 12, wherein the manifold comprises quick connection ports.

14. The patient support apparatus of claim 1, wherein the mattress is an inflatable mattress comprising a plurality of inflatable cushions.

15. The patient support apparatus of claim 1, wherein the mattress comprises an upper layer of inflatable cushions coupled to a lower layer of inflatable cushions.

16. The patient support apparatus of claim 15, wherein the lower layer of inflatable cushions are fluidly coupled to one another to form a single zone.

17. The patient support apparatus of claim 15, wherein the upper layer of inflatable cushions comprises multiple zones.

18. The patient support apparatus of claim 17, wherein the zones comprise a head zone, a shoulder zone, a body zone and a foot zone.

19. The patient support apparatus of claim 1, further comprising a substantially rigid platform disposed between the turning bladders and the mattress.

20. The patient support apparatus of claim 1, wherein each turning bladder has a width between about 10-25% of the width of the mattress.

21. (canceled)

22. The patient support apparatus of claim 1, wherein each turning bladder has a length between 5-15% of the length of the mattress.

23. (canceled)

24. The patient support apparatus of claim 1, wherein each turning bladder has a volume in an expanded condition between approximately 4-20% of a volume of the mattress.

25-35. (canceled)

36. A method of turning a mattress comprising the steps of:
inflating the first plurality of low-volume turning bladders of the patient support apparatus of claim 1 with air from an air supply; and
turning the mattress as the first plurality of low-volume turning bladders inflate to an expanded state, wherein the air supply supplies air at between about 0.1-100 L/min at a pressure between 1-200 mmHg to inflate the first plurality of bladders.
